(19) United States
(12) Patent Application Publication
(10) Pub. No.: US 2007/0226692 A1
(43) Pub. Date: Sep. 27, 2007

(54) IMAGE PROCESSING APPARATUS AND IMAGE PROCESSING METHOD

(76) Inventors: Takumi NOZAWA, Kanagawa (JP); Hiroyuki Kawamoto, Kanagawa (JP); Toshiya Hikita, Tokyo (JP); Tomoyuki Yoshida, Tokyo (JP); Shuji Kimura, Kanagawa (JP); Manabu Komatsu, Tokyo (JP); Takeharu Tone, Kanagawa (JP); Toshimi Yamamura, Kanagawa (JP); Satoshi Ohkawa, Tokyo (JP); Atsushi Togami, Kanagawa (JP); Yasunobu Shirata, Tokyo (JP); Akira Murakata, Tokyo (JP); Yukihiko Tamura, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/689,762

(22) Filed: Mar. 22, 2007

(30) Foreign Application Priority Data
Mar. 24, 2006 (JP) 2006-082089

(51) Int. Cl. G06F 9/44

(52) U.S. Cl. 717/124

(57) ABSTRACT

An image processing apparatus is disclosed. The image processing apparatus includes: an image processing unit configured to perform a plurality of image processes on image data that is input to the image processing apparatus; a unit configured to receive a specified function; an image debugging interface unit configured to output the image data on which an image process, of the plurality of image processes, corresponding to the specified function has been performed to an external apparatus in a debugging mode; and an image output unit configured to output the image data on which the image process corresponding to the specified function and following at least one image process of the plurality of image processes have been performed in the debugging mode.

### BACKGROUND OF THE INVENTION

1. Field of the Invention

The present invention relates to an image processing apparatus including at least an image input unit for inputting image data, an image processing unit for applying at least one image process to the image data, and an image output unit for outputting a process result by the image processing unit.

2. Description of the Related Art

In recent years, digital copying machines for processing digitized image data have emerged with the development of line sensor reading apparatuses including CCD (charge coupled device) photoelectric conversion elements and laser writing apparatuses.

Since the digital copying machine includes multiple functions such as copying functions, facsimile functions, printer functions, scanner functions and the like, it has been called a multifunctional machine (or multifunctional peripheral: MFP).

In addition, functions included in the multifunctional machine have been diversified in line with development of technology related to the multifunctional machine such as increase of memory capacity and reduction of cost for HDD drives (magnetic disc drive), speed-up and spread of network communications technology, improvement of processing ability of CPU (central processing unit), and development of technology (standardization of characteristics and compression format and the like) related to digital image data.

In addition, usage of the multifunctional machine in an office has been diversified. For example, a small multifunctional machine is placed by the side of a personal computer as a pair so that each user can easily use functions of a copier, a facsimile, a printer and a scanner. In another situation, a middle-sized multifunctional machine is shared by a plurality of users for each section or department, and functions of sort, punch, staple and the like are used to improve productivity to some extent. Further, a large-sized multifunctional machine that provides high productivity and high quality is used in a department mainly performing copy related work in a company, or in a company running copy business.

Japanese Laid-Open Patent Application

No. 2006-011588 (to be referred to as patent document 1) relates to the technical field of the present invention.

By the way, importance of information value in business is well-known, and it is required to convey information not only quickly, accurately and reliably but also in a way easy to understand and effectively. New functions for efficiently dealing with information using digital data have been provided in line with speed-up/spread of communications technology, increase of capacity/reduction of cost/downsizing of memory, and improvement of performance of personal computers, so that it is desired to provide new functions and to integrate the functions for the multifunctional machine that deals with digital image data that is a part of digital data.

However, there is a tendency that the size of the multifunctional machine is decreased as the functions of the multifunctional machine are improved, so that limitation for board layout has become strict for image processing apparatuses.

In addition, as the functions advance, a plurality of debugging I/Fs are required, so that limitation to board layout and cost-up required for debugging function implementation becomes a problem

### SUMMARY OF THE INVENTION

An object of the present invention is to provide an image processing apparatus that can reduce cost for implementing a debugging function.

The object is achieved by an image processing apparatus including:

an image processing unit configured to perform a plurality of image processes on image data that is input to the image processing apparatus;

a unit configured to receive a specified function;

an image debugging interface unit configured to output the image data on which an image process, of the plurality of image processes, corresponding to the specified function has been performed to an external apparatus in a debugging mode; and

an image output unit configured to output the image data on which the image process corresponding to the specified function and following at least one image process of the plurality of image processes have been performed in the debugging mode.

According to the present invention, it becomes possible to output, from the image debugging interface unit, image data on which desired image process has been performed. In addition to that, it becomes possible to output image data from the image output unit wherein all of following image processes have been performed on the image data. Thus, cost required for implementing debugging function can be decreased, board layout can be simplified, and board debugging such as failure determination when analyzing a malfunction becomes efficient.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing an example of an image processing apparatus according to an embodiment of the present invention;

FIG. 2 is a drawing for explaining an example of operation of the image processing apparatus in a normal operation mode;

FIG. 3 is a flowchart (1) showing a first example of operation of the image processing apparatus;

FIG. 4 is a flowchart (2) showing the first example of operation of the image processing apparatus;

FIG. 5 is a flowchart (1) showing a second example of operation of the image processing apparatus;

FIG. 6 is a flowchart (2) showing the second example of operation of the image processing apparatus;

FIG. 7 is a flowchart (1) showing a third example of operation of the image processing apparatus;

FIG. 8 is a flowchart (2) showing the third example of operation of the image processing apparatus.

### DETAILED DESCRIPTION OF THE PREFERRED EMBODIMENTS

In the following, preferred embodiments of the present invention are described with reference to drawings.

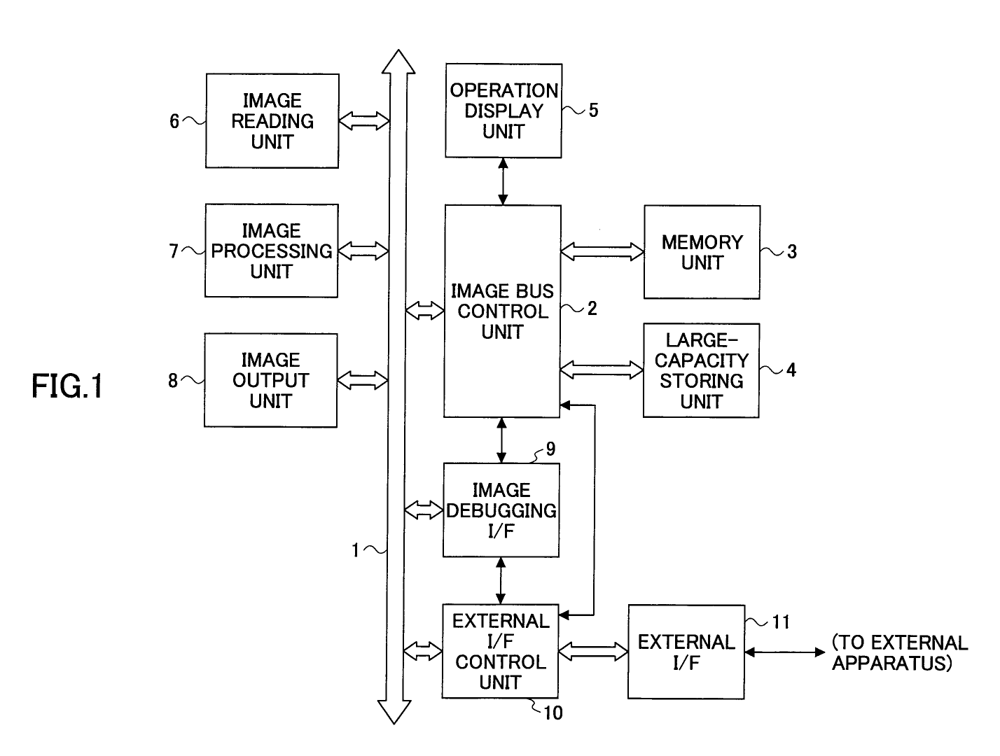

FIG. 1 shows an example of an image processing apparatus according to an embodiment of the present invention.

As shown in the figure, the image processing apparatus includes an image bus 1, an image bus control unit 2, a memory unit 3, a large-capacity storing apparatus 4, an operation display unit 5, an image reading unit 6, an image processing unit 7, an image outputting unit 8, an image debugging I/F, an external I/F control unit 10, and an external I/F 11.

The image bus 1 forms a path for exchanging image data among components in the image processing apparatus. The image bus control unit 2 controls the exchange of the image data over the image bus 1. The memory unit 3 stores intermediate data in processing and the like. The large-capacity storing apparatus 4 is a magnetic disc apparatus and the like that stores large-sized data files and the like. The operation display unit 5 is for a user to operate the image processing apparatus and includes various operation keys and a display apparatus.

The image reading unit 6 is a scanner and the like for reading image data of a document. The image processing unit 7 performs various functions (image processes), on image data, such as correction, conversion, recognition, editing, data embedding, embedded data extraction and the like. The image output unit 8 outputs image data onto a medium such as a paper.

The image debugging interface circuit 9 exchanges various data between the image processing apparatus and an external apparatus when the image processing apparatus is in a debugging mode. It is desirable to provide only one image debugging interface circuit 9 in the image processing apparatus. The external interface control unit 10 exchanges various data such as the image data between the image processing apparatus and an external apparatus (a personal computer, for example) connected via the external interface circuit 11.

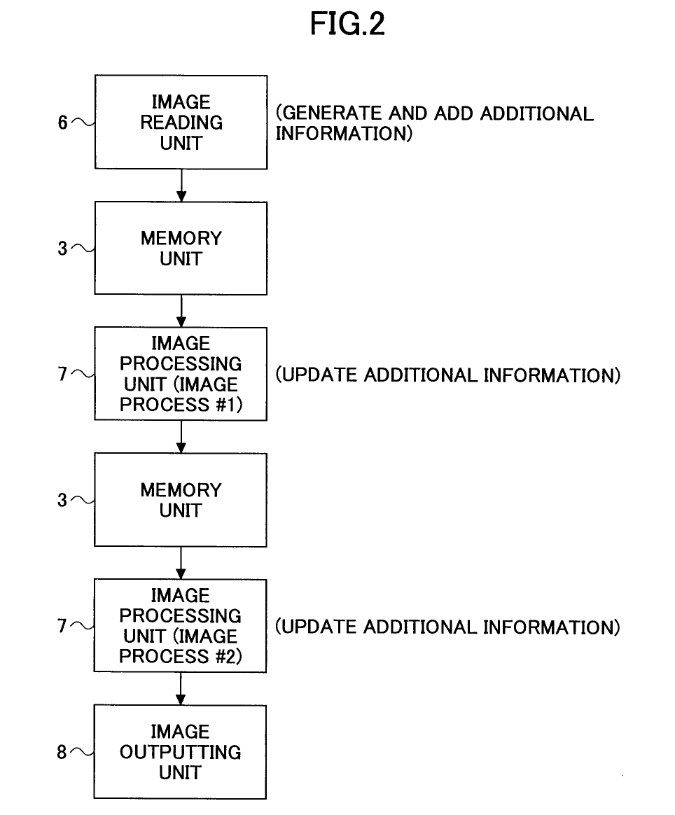

The image processing apparatus having the above-mentioned configuration operates in a way as shown in FIG. 2 in a normal operation mode. Control of exchanging data among the components is performed by the image bus control unit 2.

As shown in FIG. 2, the image reading unit 6 reads a document image, and in addition to that, additional information indicating that the read image data has been processed by the image reading unit 6 is generated so that the additional information is added to the image data read and obtained by the image reading unit 6. By the way, in addition to the normal reading process, the image reading unit 6 performs correction mainly depending on the scanner such as inter-line correction, shading correction and the like. Accordingly, even though various scanners are connected, constant image data that does not depend on the scanner can be obtained on the memory.

The image data to which the additional information is added is temporarily stored in the memory unit 3. After that, the image data is transferred to the image processing unit 7 so that a predetermined first image process #1 is applied. After the image process #1 is applied, the additional information added to the image data is changed to information indicating that the image process #1 has been performed on the image data.

After the image process #1 is performed, the image data with the additional information is temporarily stored in the memory unit 3. After that, the image data with the additional information is transferred to the image processing unit 7 so that a predetermined second image process #2 is performed on the image data. After the image process #2 is performed, the additional information added to the image data is changed to information indicating that the image process #2 has been performed on the image data.

After the image process #2 is performed, the image data from which the additional information is deleted is output to the image output unit 8 so that image displaying or recording to a paper is performed.

In the present embodiment, a debugging mode can be set for performing operation check and the like for a particular image process function. In the debugging mode, by using the image debugging interface circuit 9, image data in the middle of processing can be output, or image data for debugging, instead of the image data read by the image reading unit 6, can be read in.

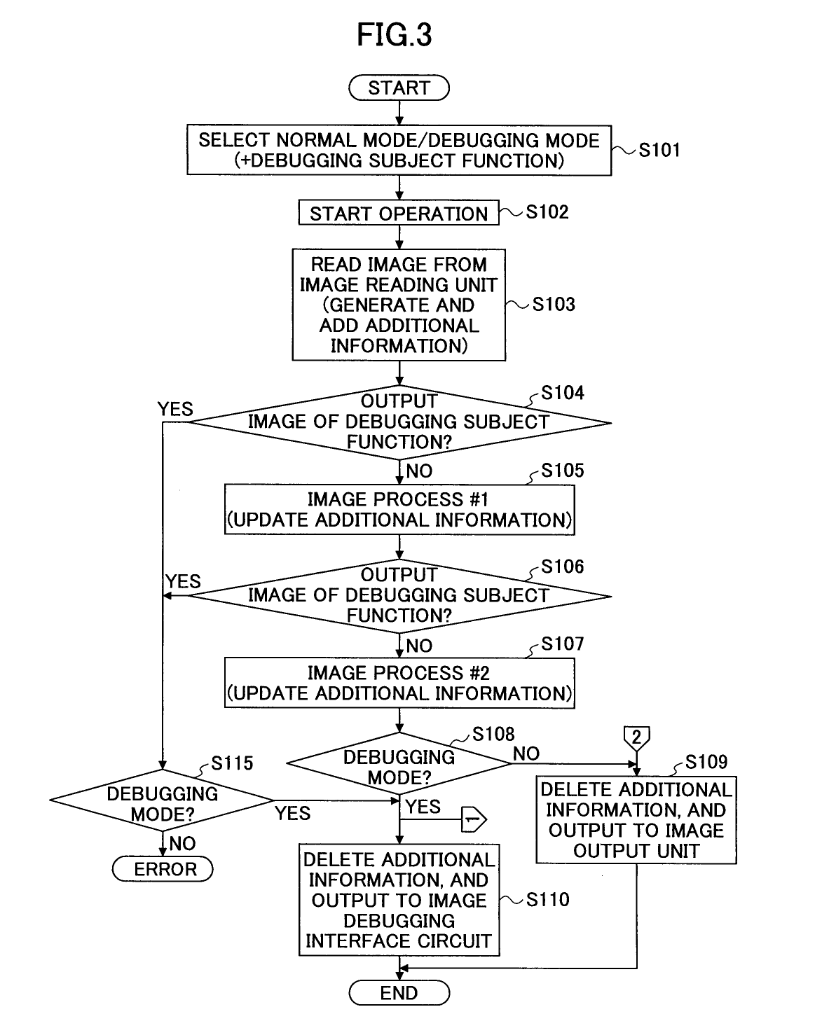

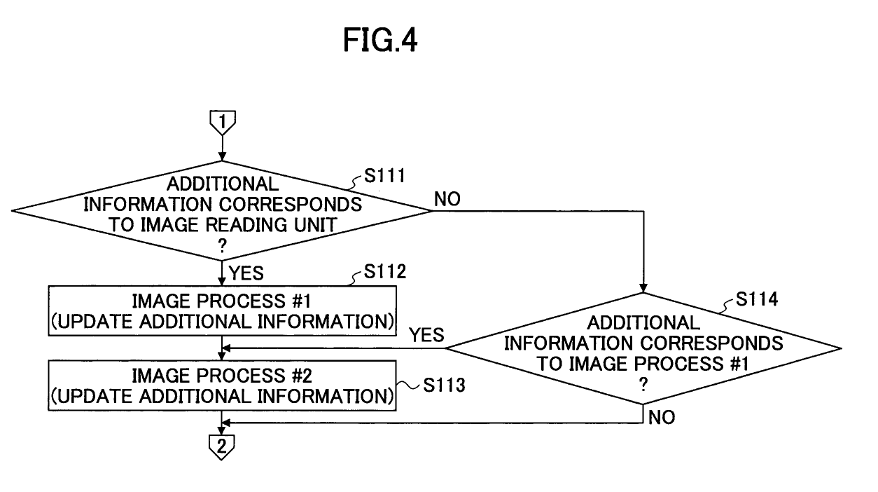

FIGS. 3 and 4 show an example of operation of the image processing apparatus.

First, in step 101, the user selects a normal mode or a debugging mode from the operation display unit 5 or from an external apparatus. When the debugging mode is selected, the user also selects a debugging subject function wherein image data on which the debugging subject function is performed is output via the image debugging interface circuit 9.

Next, when copy operation starts in step 102, the image reading unit 6 reads image data, and additional information for identifying that the image data is an output from the image reading unit 6 is added to the data in step 103.

The output image data is temporarily stored in the memory unit 3 via the image bus control unit 2, and identification of the additional information is performed by the image bus control unit 2. Then, the image bus control unit 4 compares the debugging subject function that is set beforehand with the additional information identification result in step 104.

When they are not the same (No in step 104), the image processing unit 7 performs the image process #1 on the image data output from the memory unit 3, and the additional information is updated to information for identifying that the data is an output from a unit for the image process #1 in step 105.

The output image data is temporarily stored in the memory unit 3 via the image bus control unit 2, and identification of the additional information is performed by the image bus control unit 2 in step 106. Then, the image processing apparatus compares the debugging subject function with the additional information identification result. When they are not the same (No in step 106), the image processing unit 7 performs the image process #2 on the image data output from the memory unit 3, and the additional information is updated to information for identifying that the data is an output of the image process #2 in step 107. The output data is temporarily stored in the memory unit 3 via the image bus control unit 2.

Next, it is determined whether a current mode is the debugging mode in step 108. When the current mode is not the debugging mode (No in step 108), the additional information is deleted from the image data output from the memory unit 3, and the image data is output to the image output unit 8 in step 109.

On the other hand, when the current mode is the debugging mode (Yes in step 108), the additional information is deleted from the image data output from the memory unit 3 and the image data is output via the image debugging interface circuit 9 in step 110.

In addition to that, when the current mode is the debugging mode, it is checked whether the additional information corresponds to the image reading unit 6 by the image bus control unit in step 111. By the way, the image data branching as shown in the flowchart may be performed by the image bus control unit 2 or may be performed by the image debugging interface circuit 9. When the result of determination in step 111 is Yes, the image process #1 is performed on the image data that is the same as the data output via the image debugging interface circuit 9, and the additional information is updated in step 112. Next, the image process #2 is performed and the additional information is updated in step 113, and the process goes to step 109, and the image data is output to the image output unit 8.

When the result of the determination of the step 111 is No, it is checked whether the additional information corresponds to the image process #1 in step 114. When the result of the determination in step 114 is Yes, the process goes to step 113, and processes after that are performed. When the result of the determination in step 114 is No, since the additional information corresponds to image process #2, the process goes to step 109, and the image data is output to the image output unit 8.

When the result of the determination in step 106 is Yes, or when the result of the determination in step 104 is Yes, it is determined whether the current mode is the debugging mode in step 115. When the current mode is the debugging mode (Yes in step 115), the process goes to steps 110 and 111 and processes after that are performed.

When the result of the determination of step 115 is No, the operation terminates as an error termination.

According to the above-mentioned operation, an image data on which desired image process, which is a subject for debugging, has been performed can be output via the image debugging interface circuit 9, and in addition to that, remaining processes are performed on the image data on which the desired function has been performed so that image data on which all of the processes have been performed can be output via the image output unit 8.

In the above-mentioned example, image data for debugging, instead of the image data read by the image reading unit 6, may be input via the image debugging interface circuit 9. In this case, the image bus control unit 2 or the image debugging interface circuit 9 adds additional information to the image data input via the image debugging interface circuit 9, wherein the additional information indicates an image process previous to the debugging subject function, for example. In addition, the image bus control unit 2 can be configured to determine the additional information added to the image data input via the image debugging interface circuit 9 so as to send the image data to a unit corresponding to an image process next to an image process corresponding to the additional information. Accordingly, the image processing apparatus can output image data on which only desired process for debugging has been performed to the image debugging interface circuit 9.

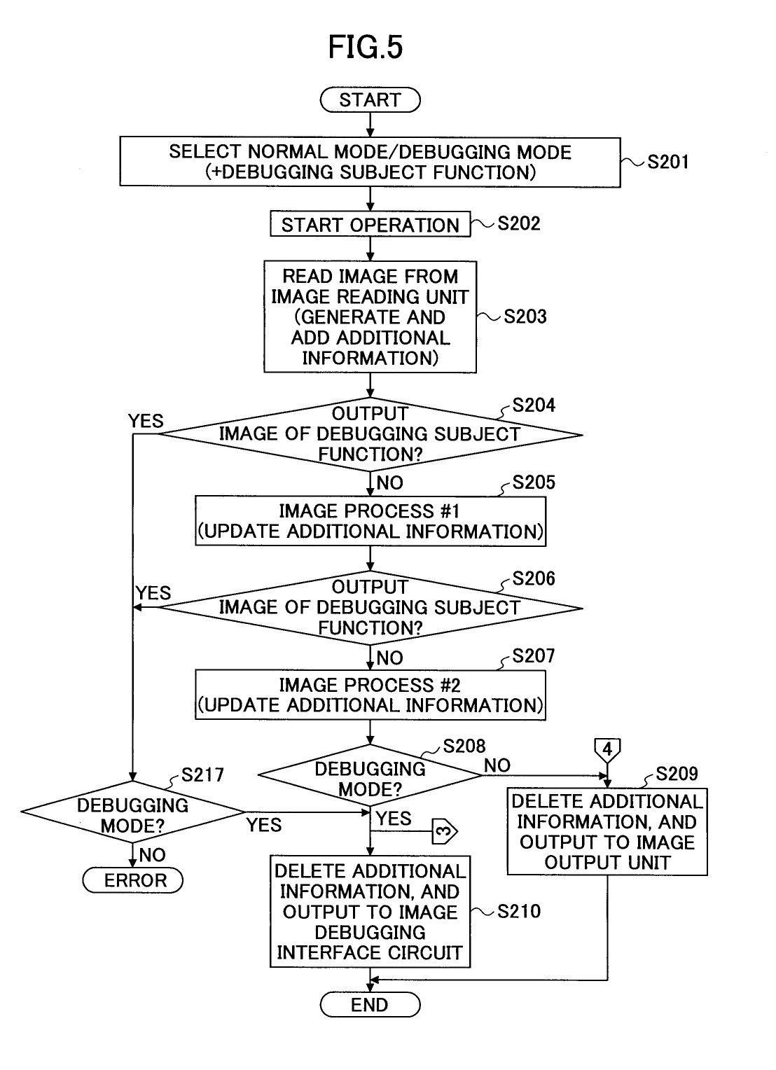

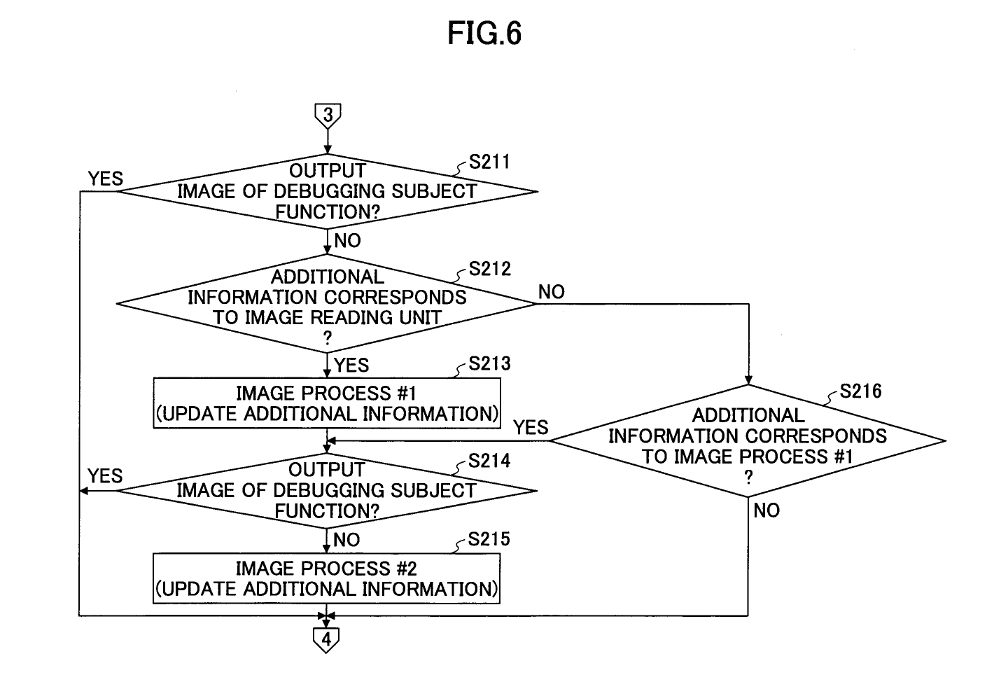

FIGS. 5 and 6 show another example of operation of the image processing apparatus.

First, in step 201, the user selects a normal mode or a debugging mode from the operation display unit 5 or from an external apparatus. When the debugging mode is selected, the user also selects a debugging subject function where image data on which the debugging subject function is performed is output to the image debugging interface circuit 9 and to the image output unit 8.

Next, when copy operation starts in step 202, the image reading unit 6 reads image data, and the additional information for identifying that the image data is an output from the image reading unit 6 is added to the image data in step 203.

The output image data is temporarily stored in the memory unit 3 via the image bus control unit 2, and identification of the additional information is performed by the image bus control unit 2. Then, the image bus control unit 2 compares the debugging subject function that is set beforehand with the additional information identifying result in step 204.

When they are not the same (No in step 204), the image processing unit 7 performs the image process #1 on the image data output from the memory unit 3, and the additional information is updated to information for identifying that the image data is an output of the image process #1 in step 205.

The output image data is temporarily stored in the memory unit 3 via the image bus control unit 2, and identification of the additional information is performed by the image bus control unit 2 in step 206. Then, the image bus control unit 2 compares the debugging subject function that is set beforehand with the additional information identifying result. When they are not the same (No in step 206), the image processing unit 7 performs the image process #2 on the image data output from the memory unit 3, and the additional information is updated to information for identifying that the image data is an output of the image process #2 in step 207. The output data is temporarily stored in the memory unit 3 via the image bus control unit 2.

Next, it is determined whether a current mode is the debugging mode in step 208. When the current mode is not the debugging mode (No in step 208), the additional information is deleted from the image data output from the memory unit 3, and the image data is output to the image output unit 8 in step 209.

On the other hand, when the current mode is the debugging mode (Yes in step 208), the additional information is deleted from the image data output from the memory unit 3, and the image data is output to the image debugging interface circuit 9 in step 210.

In addition to that, it is checked whether the image data is an output image of the function that is set in step 211 by the image bus control unit 2. When the result of determination in step 211 is Yes, the process goes to step 209 and the image data is output to the image output unit 9.

When the result of determination in step 211 is No, it is determined whether the additional information corresponds to the image reading unit 6 in step 212. When the result of determination in step 212 is Yes, the image process #1 is performed on the image data output from the image debugging interface circuit 9 and the additional information is updated in step 213. Then, it is checked whether the additional information at that time corresponds to an output image of the set function in step 214.

When the result of determination in step 214 is Yes, the process goes to step 209, and the image data is output to the image output unit 8.

When the result of determination in step 214 is No, the image process #2 is performed and the additional information is updated in step 215, and the process goes to step 209, and the image data is output to the image output unit 8.

When the result of the determination of the step 211 is No, it is checked whether the additional information corresponds to the image process #1 in step 216. When the result of the determination in step 216 is Yes, the process goes to step 214, and processes after that are performed. When the result of the determination in step 216 is No, since the additional information corresponds to image process #2, the process goes to step 209, and the image data is output to the image output unit 8.

When the result of the determination in step 206 is Yes, or when the result of the determination in step 204 is Yes, it is determined whether the current mode is the debugging mode in step 217. When the current mode is the debugging mode (Yes in step 217), the process goes to steps 210 and 211 and processes after that are performed.

When the result of the determination of step 217 is No, the operation terminates as an error termination.

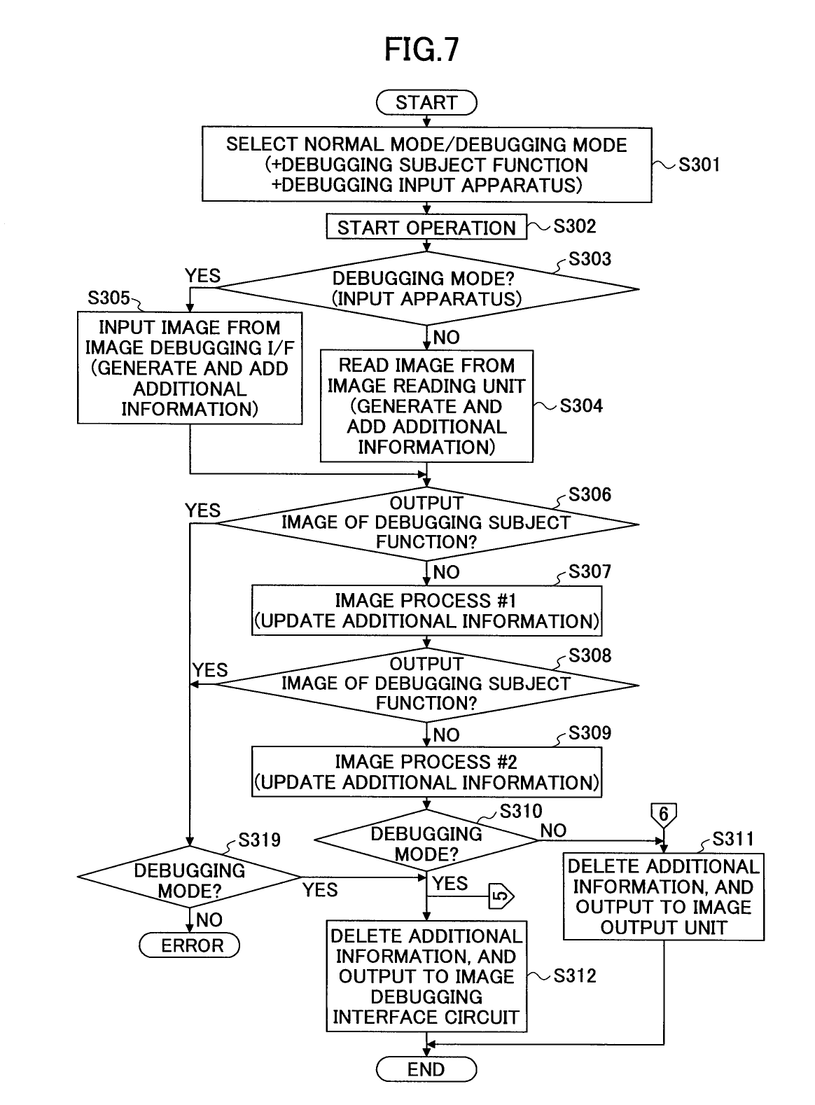

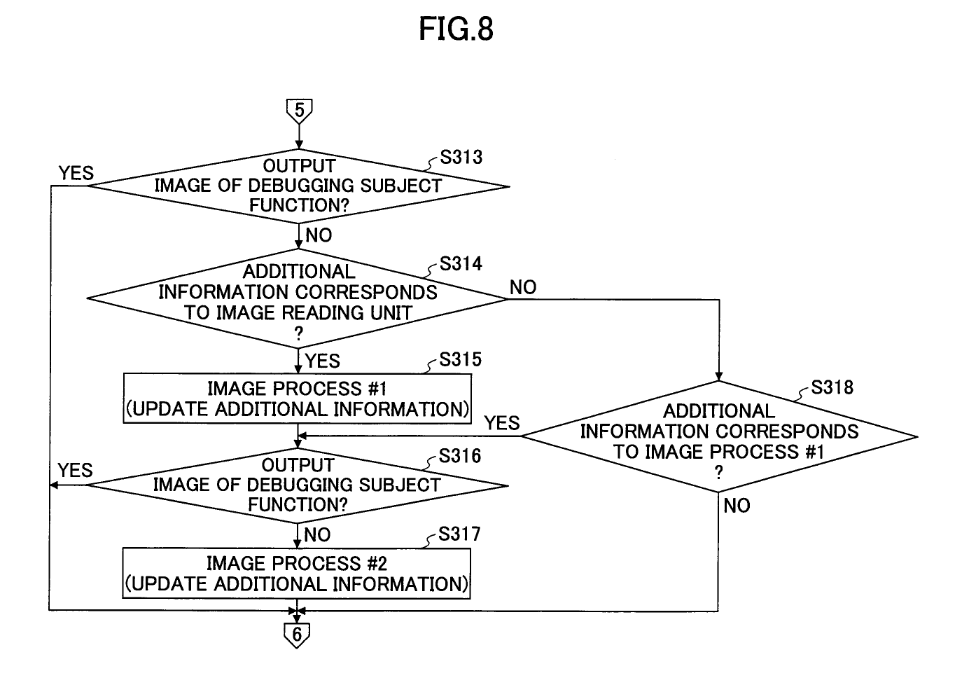

FIGS. 7 and 8 shows still another example of operation of the image processing apparatus. In this example, as mentioned before, image data for debugging, instead of the image data read by the image reading unit 6, is input via the image debugging interface circuit 9. In this example, the image bus control unit or the image debugging interface circuit 9 adds additional information to image data input via the image debugging interface circuit 9, wherein the additional information indicates a function previous to the debugging subject function, for example.

First, in step 301, the user selects a normal mode or a debugging mode from the operation display unit 5 or from an external apparatus. When the debugging mode is selected, the user also selects a debugging subject function wherein image data on which the debugging subject function is performed is output to the image debugging interface circuit 9 and the image output unit 8 in step 301. In addition, the user specifies that image data for debugging is input via the image debugging interface circuit 9.

Next, when copy operation starts in step 302, it is checked whether the debugging mode is set in step 303. When the result of the determination in step 303 is No, the image reading unit 6 reads image data, and the additional information for identifying that the data is an output from the image reading unit 6 is added to the data in step 304. When the result of the determination in step 303 is Yes, image data is input from the image debugging interface circuit 9, and above-mentioned additional information is added in step 305. As mentioned before, the additional information may be information indicating an image process next previous to the debugging subject function.

The input image data is temporarily stored in the memory unit 3 via the image bus control unit 2, and identification of the additional information is performed by the image bus control unit 2. Then, the image processing apparatus compares the debugging subject function that is set beforehand with the additional information identifying result in step 306.

When they are not the same (No in step 306), the image processing unit 7 performs the image process #1 on the image data output from the memory unit 3, and the additional information is updated to information for identifying that the data is an output of the image process #1 in step 307. By the way, in stead of the image process #1, the image bus control unit 2 may send the image data to a unit of an image process next to an image process corresponding to the additional information so that the image process corresponding to the additional information is performed.

The output image data is temporarily stored in the memory unit 3 via the image bus control unit 2, and identification of the additional information is performed by the image bus control unit 2 in step 308. Then, the image processing apparatus compares the debugging subject function that is set beforehand with the additional information identifying result. When they are not the same (No in step 308), the image processing unit 7 performs the image process #2 on the image data output from the memory unit 3, and the additional information is updated to information for identifying that the image data is an output of the image process #2 in step 309. The output data is temporarily stored in the memory unit 3 via the image bus control unit 2.

Next, it is determined whether a current mode is the debugging mode in step 310. When the current mode is not the debugging mode (No in step 310), the additional information is deleted from the image data output from the memory unit 3, and the image data is output to the image output unit 8 in step 311.

On the other hand, when the current mode is the debugging mode (Yes in step 310), the additional information is deleted from the image data output from the memory unit 3 and the image data is output via the image debugging interface circuit 9 in step 312.

In addition to that, it is checked whether the image data is an output image of the function that is set in step 313. When the result of determination in step 313 is Yes, the process goes to step 311 and the image data is output to the image output unit 8.

When the result of determination in step 313 is No, it is determined whether the additional information corresponds to the image reading unit 6 in step 314. When the result of determination in step 314 is Yes, the image process #1 is performed on the image data that is the same as the data output from the image debugging interface circuit 9 and the additional information is updated in step 315. Then, it is checked whether the additional information at that time corresponds to an output image of the set function in step 316.

When the result of determination in step 316 is Yes, the process goes to step 311, and the image data is output to the image output unit 8.

When the result of determination in step 316 is No, the image process #2 is performed and the additional information is updated in step 317, and the process goes to step 311, and the image data is output to the image output unit 8.

When the result of the determination of the step 313 is No, it is checked whether the additional information corresponds to the image process #1 in step 318. When the result of the determination in step 318 is Yes, the process goes to step 316, and processes after that are performed. When the result of the determination in step 318 is No, since the additional information corresponds to image process #2, the process goes to step 311, and the image data is output to the image output unit 8.

When the result of the determination in step 308 is Yes, or when the result of the determination in step 306 is Yes, it is determined whether the current mode is the debugging mode in step 319. When the current mode is the debugging mode (Yes in step 319), the process goes to steps 312 and 313 and processes after that are performed.

When the result of the determination of step 319 is No, the operation terminates as an error termination.

In this example, the procedure shown in FIG. 8 can be replaced with the procedure shown in FIG. 4.

Accordingly, it becomes possible to output, from the image debugging interface circuit 9, image data read from the image reading unit 6 or image data on which desired image process has been performed. In addition to that, it becomes possible to output image data from the image output unit 8 wherein all of following image processes have been performed on the image data. Thus, cost required for implementing debugging function for a board can be decreased, board layout can be simplified, and board debugging such as failure determination when analyzing a malfunction becomes efficient.

In addition, since image data on which desired image process has been performed can be output to the image debugging interface circuit 9 and to the image output unit 8, board debugging such as failure determination when analyzing a malfunction becomes further efficient.

In addition, it becomes possible to input image data from the image reading unit 6 or image data for debugging on which desired image process has been performed. Thus, it becomes more efficient to perform tuning and debugging for a particular process in the image processing unit.

By the way, in the above embodiment, although an image processing apparatus including a copying function is described, the present invention can be also applied to a multifunctional machine further including a facsimile function and a printer function.

In addition, as the external apparatus, an external data processing apparatus connected via a network and the like can be used. In addition, although image processes #1 and #2 are shown in the above-mentioned examples, it is needless to say that more processes may be performed.

According to the embodiments of the present invention, an image processing apparatus is provided, in which the image processing apparatus includes: an image processing unit configured to perform a plurality of image processes on image data that is input to the image processing apparatus; a unit configured to receive a specified function; an image debugging interface unit configured to output the image data on which an image process, of the plurality of image processes, corresponding to the specified function has been performed to an external apparatus in a debugging mode; and an image output unit configured to output the image data on which the image process corresponding to the specified function and following at least one image process of the plurality of image processes have been performed in the debugging mode.

The image processing apparatus may further includes an image input unit configured to read a document image to generate the image data and input the image data into the image processing apparatus. The image data may be input via the image debugging interface unit. Additional information corresponding to a particular image process may be added to the image data when the particular image process has been performed on the image data, and the image processing apparatus may further includes a control unit to cause the image debugging interface unit to output the image data when the control unit determines that additional information added to the image data corresponds to the image process corresponding to the specified function.

Also, the control unit may further cause the image processing unit to perform image processes following the image process corresponding to the specified function on the image data, and cause the image output unit to output the image data on which the image processes have been performed.

Also, according to the embodiments, an image processing apparatus including an image input unit, an image processing unit, an image debugging interface unit and an image output unit is provided. In a normal operation mode, the image processing unit performs a plurality of image processes on image data input by the image input unit in predetermined order so that the image output unit outputs the image data on which the image processes has been performed. In a debugging mode, the image processing apparatus outputs the image data on which a desired image process has been performed via the image debugging interface unit, and in addition to that image processes following the desired image process are performed on the image data.

The present invention is not limited to the specifically disclosed embodiment, and variations and modifications may be made without departing from the scope of the present invention.

The present application contains subject matter related to Japanese patent application No. 2006-082089, filed in the JPO on Mar. 24, 2006, the entire contents of which are incorporated herein by reference.

What is claimed is:

1. An image processing apparatus comprising:
an image processing unit configured to perform a plurality of image processes on image data that is input to the image processing apparatus;
a unit configured to receive a specified function;
an image debugging interface unit configured to output the image data on which an image process, of the plurality of image processes, corresponding to the specified function has been performed to an external apparatus in a debugging mode; and
an image output unit configured to output the image data on which the image process corresponding to the specified function and following at least one image process of the plurality of image processes have been performed in the debugging mode.

2. The image processing apparatus as claimed in claim 1, the image processing apparatus further comprising an image input unit configured to read a document image to generate the image data and input the image data into the image processing apparatus.

3. The image processing apparatus as claimed in claim 1, wherein the image data is input via the image debugging interface unit.

4. The image processing apparatus as claimed in claim 1, wherein additional information corresponding to a particular image process is added to the image data when the particular image process has been performed on the image data,
the image processing apparatus further comprising a control unit to cause the image debugging interface unit to output the image data when the control unit determines that additional information added to the image data corresponds to the image process corresponding to the specified function.

5. The image processing apparatus as claimed in claim 4, wherein the control unit further causes the image processing unit to perform image processes following the image process corresponding to the specified function on the image data, and causes the image output unit to output the image data on which the image processes have been performed.

6. An image processing method performed by an image processing apparatus, the image processing method comprising the steps of:
receiving a specified function;
performing an image process corresponding to the specified function on input image data by an image processing unit;
outputting the image data on which the image process corresponding to the specified function has been performed to an external apparatus via an image debugging interface unit; and
performing at least one image process following the image process corresponding to the specified function on the image data on which the image process corresponding to the specified function has been performed so as to output the image data via an image output unit.

7. The image processing method as claimed in claim 6, wherein the image data is input from an image input unit configured to read a document image to generate the image data.

8. The image processing method as claimed in claim 6, wherein the image data is input via the image debugging interface unit.

9. The image processing method as claimed in claim 6, wherein additional information corresponding to a particular image process is added to the image data when the particular image process has been performed on the image data, and
a control unit in the image processing apparatus cause the image debugging interface unit to output the image data when the control unit determines that additional information added to the image data corresponds to the image process corresponding to the specified function.

10. The image processing method as claimed in claim 9, wherein the control unit further causes the image processing unit to perform image processes following the image process corresponding to the specified function, and causes the image output unit to output the image data on which all of image processes have been performed.
